(19) United States
(12) Patent Application Publication
(10) Pub. No.: US 2024/0362688 A1
(43) Pub. Date: Oct. 31, 2024

(54) USAGE FEE OUTPUT METHOD FOR OUTPUTTING ASSET USAGE FEE, INFORMATION PROCESSING APPARATUS, STORAGE MEDIUM, AND INFORMATION PROCESSING SYSTEM

(71) Applicant: Panasonic Intellectual Property Corporation of America, Torrance, CA (US)

(72) Inventor: Hiromitsu MORISHITA, Osaka (JP)

(73) Assignee: Panasonic Intellectual Property Corporation of America, Torrance, CA (US)

(21) Appl. No.: 18/765,272

(22) Filed: Jul. 7, 2024

Related U.S. Application Data
(63) Continuation of application No. PCT/JP2022/043866, filed on Nov. 29, 2022.

(30) Foreign Application Priority Data
Jan. 20, 2022 (JP) 2022-007304

(51) Int. Cl. G06Q 30/0283

(52) U.S. Cl. CPC G06Q 30/0284

(57) ABSTRACT

A communicator acquires dwelling space information regarding an asset that a leaving scheduled person living in a residence introduces into the residence and leaves in the residence when the leaving scheduled person leaves the residence. A processor derives a value of the asset based on the dwelling space information acquired in the communicator, and determines a usage fee to be paid to the leaving scheduled person by a resident scheduled person moving into the residence after the leaving scheduled person, based on the value of the asset. The communicator outputs the usage fee.

### BACKGROUND

### 1. Field

The present disclosure relates to information processing technology, and more particularly, to a usage fee output method for outputting an asset usage fee, an information processing apparatus, a storage medium, and an information processing system.

### 2. Description of the Related Art

The reinforced concrete skeleton is said to last for 100 years. However, since the business owner side of rental apartments is not interested in durability or maintenance, the number of short-lived rental apartments is increasing. In terms of management, it is required to create a mechanism that can cope with long-term rental. Therefore, in a structure of a rental apartment made of reinforced concrete, a structural skeleton and a shared facility piping of a building and an interior facility device piping portion occupied and used in the skeleton are separated structurally and clearly so as not to be mixed, and management of each section is completely separated.

As a result, management of an occupied dwelling unit is the responsibility of a resident. In addition, a history of construction content such as a design drawing, a specification, and a construction contract for each dwelling unit is converted into data in a unified format, and the data of the dwelling unit is shared and managed between a business operator and the resident (see, for example, JP 2006-331361 A).

When the resident of the rental apartment purchases domestic electric machines and appliances such as an air conditioner and a television receiver, and furniture such as a sofa and a table and installs them in a residence or changes a wallpaper, a value of a space called the residence is improved. However, in general, when the resident leaves the residence, the residence is restored to its original state. Therefore, the value of the space improved by the resident is returned to the original value. On the other hand, when a resident scheduled person who moves into the residence next desires to use the domestic electric machines and appliances or furniture installed in the residence, it is useless to return the value of the space to the original value. For this reason, it is required to efficiently improve the value of the space.

### SUMMARY

The present disclosure has been made in view of such a situation, and an object thereof is to provide technology for efficiently improving a value of a facility.

In order to solve the above problem, a method for outputting a usage fee according to an aspect of the present disclosure is a method for outputting a facility usage fee by using dwelling space information that changes with entrance and exit of a facility. The method includes: acquiring the dwelling space information regarding an asset that a first user living in the facility introduces into the facility and leaves in the facility when the first user leaves the facility; deriving a value of the asset based on the dwelling space information; determining a usage fee to be paid to the first user by a second user moving into the facility after the first user, based on the value of the asset; and outputting the usage fee.

Another aspect of the present disclosure is an information processing apparatus. This apparatus is an information processing apparatus for outputting a facility usage fee by using dwelling space information that changes with entrance and exit of a facility. The information processing apparatus includes: a communicator that acquires the dwelling space information regarding an asset that a first user living in the facility introduces into the facility and leaves in the facility when the first user leaves the facility; and a processor that derives a value of the asset based on the dwelling space information acquired in the communicator, and determines a usage fee to be paid to the first user by a second user moving into the facility after the first user, based on the value of the asset. The communicator outputs the usage fee.

Still another aspect of the present disclosure is an information processing system. The information processing system includes: a first apparatus; a second apparatus; and an information processing apparatus that outputs a facility usage fee by using dwelling space information that changes with entrance and exit of a facility. The information processing apparatus includes: a communicator that acquires, from the first apparatus, the dwelling space information regarding an asset that a first user living in the facility introduces into the facility and leaves in the facility when the first user leaves the facility; and a processor that derives a value of the asset based on the dwelling space information acquired in the communicator, and determines a usage fee to be paid to the first user by a second user moving into the facility after the first user, based on the value of the asset. The communicator outputs the usage fee to the second apparatus.

Note that arbitrary combinations of the above components and conversions of an expression of the present disclosure between a method, a device, a system, a recording medium, a computer program, and the like are also effective as aspects of the present disclosure.

### BRIEF DESCRIPTION OF THE DRAWINGS

FIGS. 1A-1D are diagrams illustrating a transition of a resident of a residence according to an embodiment;

FIGS. 2A-2D are diagrams illustrating an interior of the residence according to the embodiment;

FIG. 3 is a diagram illustrating an overview of a procedure for setting a usage fee in the residence of FIGS. 2A to 2D;

FIG. 4 is a diagram illustrating a configuration of an information processing system according to the embodiment;

FIG. 5 is a flowchart illustrating an output procedure by an information processing apparatus of FIG. 4;

FIGS. 6A-6D are diagrams illustrating a data structure of space information in the situations of FIGS. 2A to 2D;

FIG. 7 is a flowchart illustrating a procedure for determining a usage fee by the information processing apparatus of FIG. 4;

FIG. 8 is a diagram illustrating a change in value in a case where a plurality of users are involved;

FIG. 9 is a flowchart illustrating an opposition procedure by the information processing system of FIG. 4; and

FIG. 10 is a diagram illustrating another configuration of the information processing system according to the embodiment.

### DETAILED DESCRIPTION

The invention will now be described by reference to the preferred embodiments. This does not intend to limit the scope of the present invention, but to exemplify the invention.

The following embodiments illustrate preferred specific examples of the present disclosure. Therefore, numerical values, shapes, materials, components, arrangement positions and connection modes of the components, steps (processes) and the order of the steps, and the like shown in the following embodiments are merely examples, and are not intended to limit the present disclosure. Accordingly, among the components in the following embodiments, components that are not described in the independent claims indicating the top concept of the present disclosure are described as optional components. In each drawing, substantially the same configurations are denoted by the same reference numerals, and redundant description will be omitted or simplified. Hereinafter, the embodiments will be described in the order of (1) Overview, (2) Configuration, (3) First processing example, (4) Second processing example, (5) Third processing example, (6) Fourth processing example, (7) Fifth processing example, and (8) Sixth processing example.

### (1) Overview

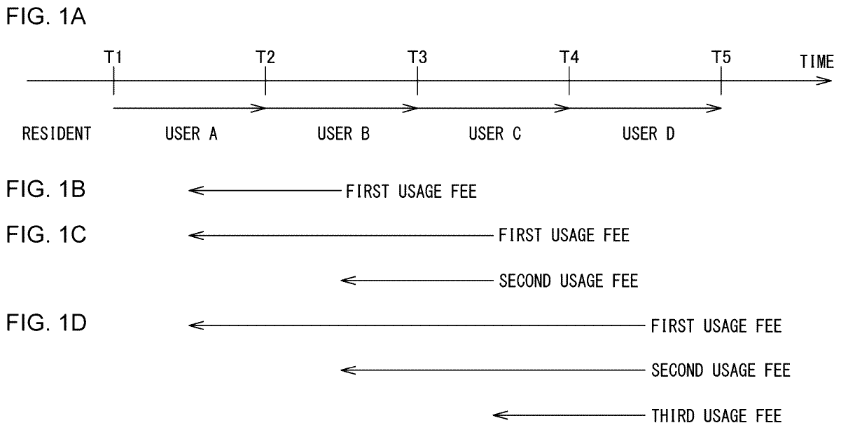

In the present embodiment, a residence 100 included in a collective residence such as a rental apartment is described. However, the subject of explanation is not limited to the residence 100, and may be an office or the like, or may be a facility collectively referring to the residence 100 and the office. FIGS. 1A to 1D illustrate a transition of a resident of the residence 100. FIG. 1A illustrates the progress of time from the left side to the right side. The time passes in the order of T1, T2, T3, T4, and T5. The resident of the residence 100 is a user A from time T1 to time T2, is a user B from the time T2 to time T3, is a user C from the time T3 to time T4, and is a user D from the time T4 to time T5. FIGS. 1B to 1D will be described later.

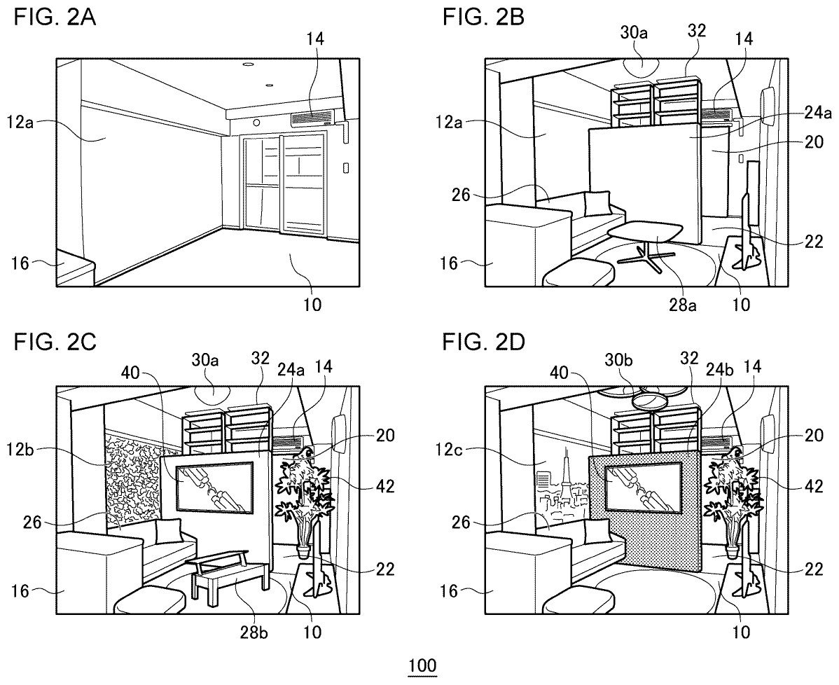

FIGS. 2A to 2D illustrate the interior of the residence 100. FIG. 2A illustrates the interior of the residence 100 before the time T1 of FIG. 1A, that is, the user A moves into the residence. The residence 100 includes a floor 10, a first wallpaper 12a, an air conditioner 14, and a shelf 16. The floor 10, the first wallpaper 12a, the air conditioner 14, and the shelf 16 are provided by an owner of the residence 100 when the residence 100 is lent to the user A. FIG. 2B illustrates the interior of the residence 100 between the times T1 and T2 in FIG. 1A, that is, while the user A lives in the residence. As compared with FIG. 2A, the residence 100 additionally includes a curtain 20, a carpet 22, a first partition 24a, a sofa 26, a first table 28a, a first ceiling light 30a, and a ceiling light 32.

In a case where the user A leaves the residence 100 at the time T2, the residence 100 of FIG. 2B is returned to the residence 100 of FIG. 2A by performing restoration to the original state by the user A so far. On the other hand, the owner of the residence 100 increases the value of the residence 100 by performing renovation and refurbishment for the purpose of increasing the asset value that decreases due to an increase in rent, deterioration, or the like. However, the user A also makes an investment in the residence 100 by introducing the curtain 20 and the like as illustrated in FIG. 2B, and the value of the residence 100 increases. Therefore, in a case where the user A leaves the residence 100, if the original state is not restored and an article such as the curtain 20 invested by the user A is taken over to the user B, the increased value of the residence 100 is also taken over. At that time, if the motivation of the user A is improved for increasing the value of the residence 100, the investment by the user A is efficiently made.

In order to realize this, in the present embodiment, the resident (user A) does not restore the asset to be invested in the residence 100 to the original state at the time of leaving, but acquires the value of the asset as the usage right, and the usage fee of the value is paid from the subsequent resident (user B) to the leaving person (user A). That is, the value of the asset invested by the resident (user A) is returned to the user A after leaving the residence 100. For the resident, the investment cost leads to the usage fee, so that the motivation of the investment is improved. In addition, for the owner of the residence 100, although the rent is not improved, the value of the residence 100 is suppressed from being reduced and the next resident can be easily found, even if the renovation and the refurbishment are not executed.

Here, the asset includes at least one of an article left in the residence 100 or an intangible asset associated with a dwelling space. The article left in the residence 100 means an article introduced into the dwelling space by a user who has used the residence 100, and includes, for example, the curtain 20, the wallpaper 12, a bed, a thin television receiver 40, and a floor board, but is not limited thereto. The intangible asset associated with the dwelling space means information associated with the residence 100 constituting the dwelling space, and includes, for example, device data accumulated by using the residence 100, a network structure, and a history of residence of a famous person, but is not limited thereto. In addition, the network structure includes setting of each electronic device (setting according to the dwelling space). This includes, for example, smart lighting timers, color temperature, and illuminance. The network structure may include a program for executing an electronic device according to the dwelling space, such as scene control.

Furthermore, in the present embodiment, dwelling space information is used when the usage fee is output, but the dwelling space information is information regarding the dwelling space that changes before and after entrance/exit of the residence 100, and includes information regarding the asset. In the following description, processing performed on the article may be similarly performed on the intangible asset.

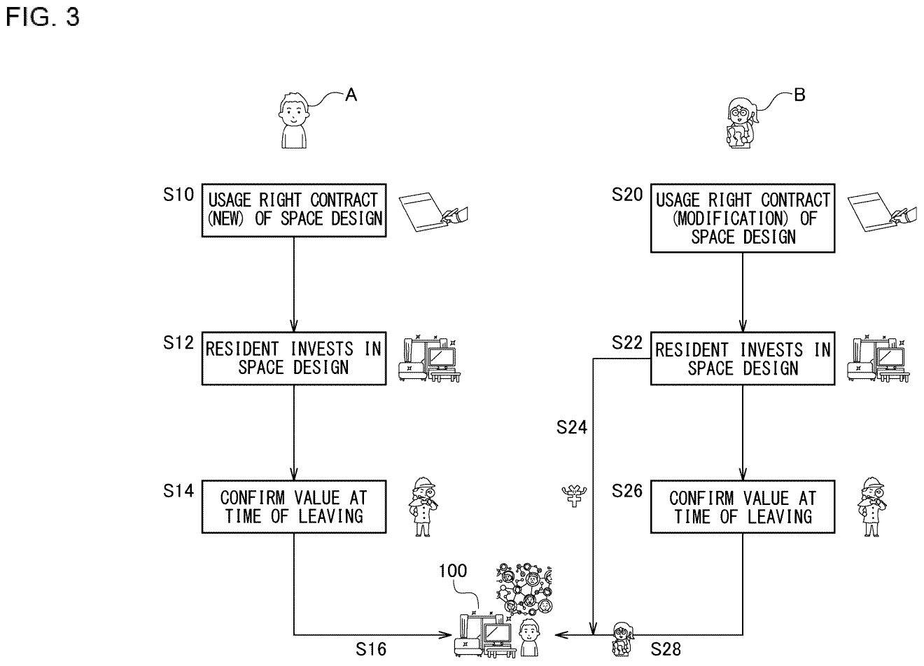

FIG. 3 illustrates an overview of a procedure for setting a usage fee in the residence 100. The user A executes the usage right contract (new) of the asset (hereinafter, also referred to as “space design”) with a management company before moving into the residence (S10). In the usage right contract, for example, “leaving the article at the time of leaving”, “the usage right of the left article belongs to the user A”, and “the rent of the residence 100 is only a base portion” are indicated. The user A invests in the space design while living in the residence 100 (S12). For example, the investment is made in the furniture or interior design, or the investment is made in the domestic electric machines and appliances or communication network designs. The user A confirms the value of the invested space design with the management company at the time of leaving (S14). As a result, the usage right for the value invested by the user A is set to the residence 100 (S16).

The user B executes the usage right contract (modification) of the space design with the management company before moving into the residence (S20). In the usage right contract, for example, “to pay, to the user A, the usage fee for the usage right of the user A”, “in a case where the article left by the user A is remodeled, the usage right becomes common between the user A and the user B”, “to leave the article introduced by the user B at the time of leaving”, “the usage right of the article introduced by the user B belongs to the user B”, and “the rent of the residence 100 is only the base portion” are indicated. The user B invests in the space design while living in the residence 100 (S22). The user B pays the usage fee to the user A (S24). For example, the usage fee is monthly payment similarly to the rent. The user B confirms the value of the invested space design with the management company at the time of leaving (S26). As a result, the usage right for the value invested by the user B is set to the residence 100 (S28).

Such a procedure is also performed for residents after the user B. As a result, since restoration to the original state is not performed, the interior of the residence 100 changes from FIGS. 2B to 2C and 2D. FIG. 2C illustrates the interior of the residence 100 between the times T2 and T3 in FIG. 1A, that is, while the user B lives in the residence. As compared with FIG. 2B, the residence 100 additionally includes a second table 28b, a thin television receiver 40, and a foliage plant 42. The second table 28b is replaced with the first table 28a.

FIG. 2D illustrates the interior of the residence 100 between the times T3 and T4 in FIG. 1A, that is, while the user C lives in the residence. As compared with FIG. 2C, the residence 100 additionally includes a second partition 24b and a second ceiling light 30b. The second partition 24b is modified from the first partition 24a, and the second ceiling light 30b is replaced with the first ceiling light 30a. The second table 28b is discarded.

In the change from FIG. 2A to FIG. 2D, as illustrated in FIG. 1B, the user B who lives in the residence pays the usage fee (hereinafter, referred to as the “first usage fee”) to the user A. As illustrated in FIG. 1C, the user C who lives in the residence pays the usage fee (hereinafter, this is also referred to as the “first usage fee”) to the user A, and pays the usage fee (hereinafter, referred to as the “second usage fee”) to the user B. Further, as illustrated in FIG. 1D, the user D who lives in the residence pays the usage fee (hereinafter, this is also referred to as the “first usage fee”) to the user A, pays the usage fee (hereinafter, this is also referred to as the “second usage fee”) to the user B, and pays the usage fee (hereinafter, referred to as the “third usage fee”) to the user C.

### (2) Configuration

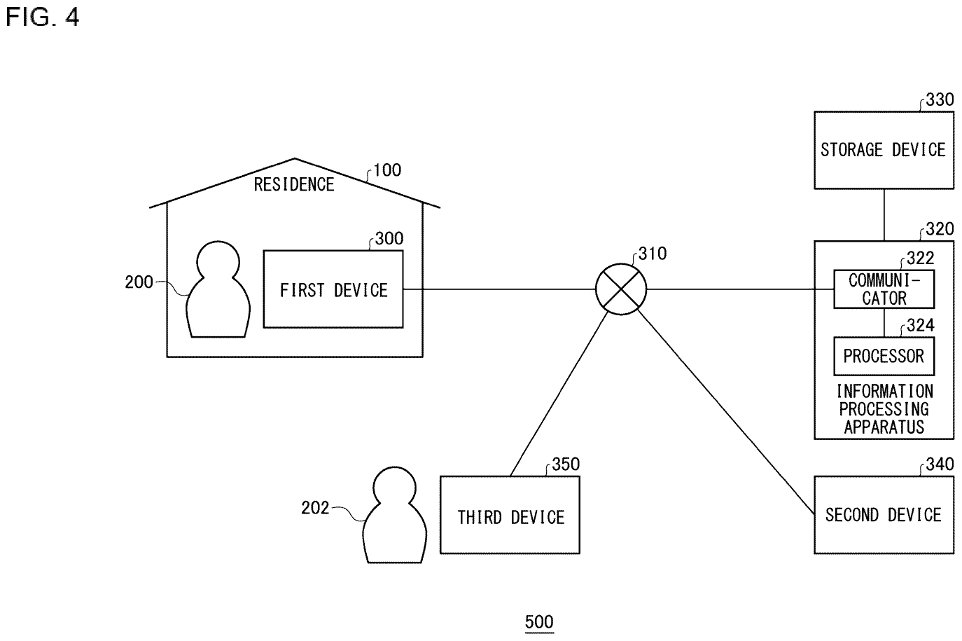

FIG. 4 illustrates a configuration of an information processing system 500. The information processing system 500 includes a first device 300, a network 310, an information processing apparatus 320, a storage device 330, a second device 340, and a third device 350. The information processing apparatus 320 includes a communicator 322 and a processor 324. The first device 300 is used by a leaving scheduled person 200 in the residence 100, and the third device 350 is used by a resident scheduled person 202.

The leaving scheduled person 200 is a user who moves into the residence 100 and plans to leave the residence 100, and the resident scheduled person 202 is a user who plans to move in the residence 100 after the leaving scheduled person 200 leaves the residence 100. At timing before the time T2 in FIG. 1A, the leaving scheduled person 200 is the user A, and the resident scheduled person 202 is the user B. At timing before the time T3 in FIG. 1A, the leaving scheduled person 200 is the user B, and the resident scheduled person 202 is the user C. At timing before the time T4 in FIG. 1A, the leaving scheduled person 200 is the user C, and the resident scheduled person 202 is the user D. Therefore, the leaving scheduled person 200 and the resident scheduled person 202 change according to the timing.

The first device 300, the information processing apparatus 320, the second device 340, and the third device 350 have a communication function, and can communicate with each other via the network 310 by being connected to the network 310. The first device 300 is, for example, an imaging device such as a 360-degree imaging device, and is installed in the residence 100. Further, the first device 300 may be an information terminal such as a personal computer, a tablet terminal, or a smartphone, and is operated by the leaving scheduled person 200. The information processing apparatus 320 is, for example, a server device, and is used by the management company. The second device 340 is, for example, an information terminal such as a personal computer, a tablet terminal, or a smartphone, and is operated by an employee or the like of the management company. Also, the third device 350 is, for example, an information terminal such as a personal computer, a tablet terminal, or a smartphone, and is operated by the resident scheduled person 202.

The first device 300 acquires information (dwelling space information) of an article (asset) installed (introduced) in the residence 100 before the leaving scheduled person 200 leaves the residence 100. In a case where the first device 300 is an imaging device, the first device 300 acquires an image including the article by imaging the interior of the residence 100 in which the article is installed (introduced). In a case where the first device 300 is an information terminal, the first device 300 acquires character information of an article installed (introduced) in the residence 100 by the operation of the leaving scheduled person 200. The character information is indicated in, for example, a list format. The first device 300 may be a combination of an imaging device and an information terminal, or may acquire a combination of an image and character information. The first device 300 transmits at least one of an image and character information as space information to the information processing apparatus 320 via the network 310.

The information processing apparatus 320 executes processing of determining a usage fee of the article (asset) introduced into the residence 100, and executes processing of payment of the determined usage fee. Further, the information processing apparatus 320 may execute processing for mediating the residence 100 to the resident scheduled person 202. Although details of these processing will be described later, the information processing apparatus 320 executes the processing using information stored in the storage device 330. For example, in the processing of determining the usage fee of the article, when the space information is received from the first device 300, the information processing apparatus 320 stores the received space information in the storage device 330. The storage device 330 stores the current space information, the past space information, and the value calculation rule. The storage device 330 may store a database relating to the article. According to the value calculation rule, the information processing apparatus 320 determines a usage fee that the resident scheduled person 202 should pay to the leaving scheduled person 200 and the user who has already left the residence 100 based on the current space information and the past space information.

When an operation is received from an employee or the like of the management company, the second device 340 transmits a signal including information according to the operation to the information processing apparatus 320 via the network 310. In addition, the second device 340 receives a processing result in the information processing apparatus 320 from the information processing apparatus 320 via the network 310. The second device 340 displays the received processing result on a display (not illustrated). The processing result displayed on the display is, for example, information of a usage fee in the residence 100.

Upon receiving the operation from the resident scheduled person 202, the third device 350 transmits a signal including information according to the operation to the information processing apparatus 320 via the network 310. In addition, the third device 350 receives a processing result in the information processing apparatus 320 from the information processing apparatus 320 via the network 310. The third device 350 displays the received processing result on a display (not illustrated). The processing result displayed on the display is, for example, information of a plurality of residences 100 that are candidates for moving into, information of a usage fee in the residence 100, and the like.

This configuration can be realized by a central processing unit (CPU), a memory, or other large scale integration (LSI) of an arbitrary computer in terms of hardware, and can be realized by a program loaded in a memory or the like in terms of software, but here, functional blocks realized by cooperation thereof are illustrated. Therefore, it is understood by those skilled in the art that these functional blocks can be realized in various forms by only hardware and a combination of hardware and software.

### (3) First Processing Example

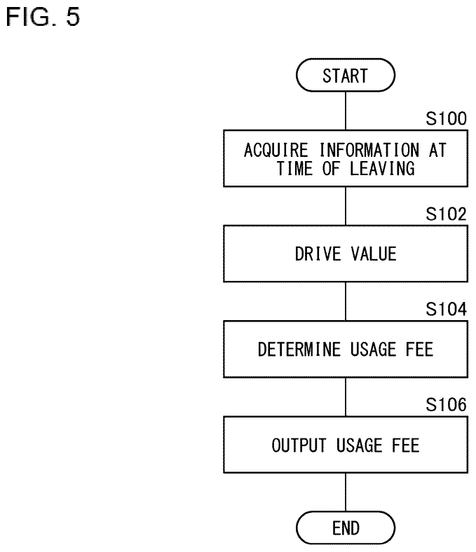

Here, with reference to FIG. 5, (3-1) processing at timing before the time T2 in FIG. 1A, (3-2) processing at timing before the time T3 in FIG. 1A, and (3-3) processing at timing before the time T4 in FIG. 1A will be described in order.

### (3-1) Processing at Timing Before Time T2

As described above, the leaving scheduled person 200 is the user A, and the resident scheduled person 202 is the user B. Further, the first device 300 in FIG. 4 transmits the space information to the information processing apparatus 320. FIG. 5 is a flowchart illustrating an output procedure by the information processing apparatus 320. The communicator 322 of the information processing apparatus 320 receives the space information from the first device 300, and the processor 324 acquires the space information from the communicator 322 (S100). In a case where the space information is an image, the processor 324 extracts an article included in the image by executing image recognition processing on the image. The processor 324 retrieves the extracted article from a database in which correspondence relations of images and names of various articles and the like are stored, thereby acquiring the name or the like of the extracted article. The database is stored in the storage device 330. Further, the processor 324 may acquire the name or the like of the article by executing Internet search via the communicator 322 using the extracted article as a search key. In a case where the space information includes character information, the processing for acquiring the name and the like of the article is omitted. Hereinafter, the character information such as the name of the article is also referred to as the “space information”. The space information includes information (first dwelling space information) regarding an article (hereinafter, referred to as a “first article”) that is introduced into the residence 100 by the user A who lives in the residence 100 and left in the residence 100 when the user A leaves the residence 100.

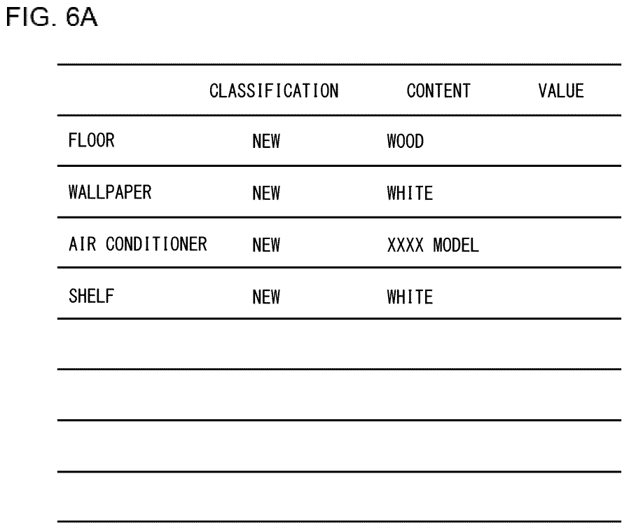

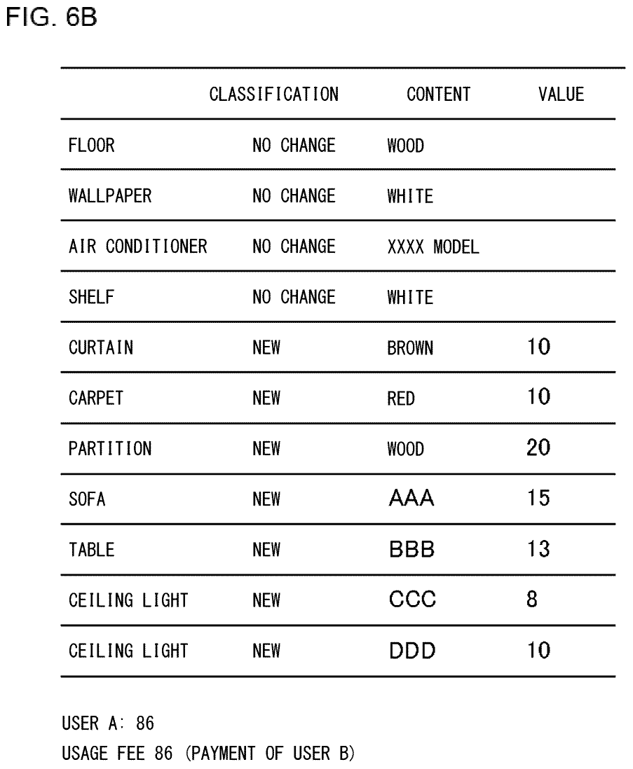

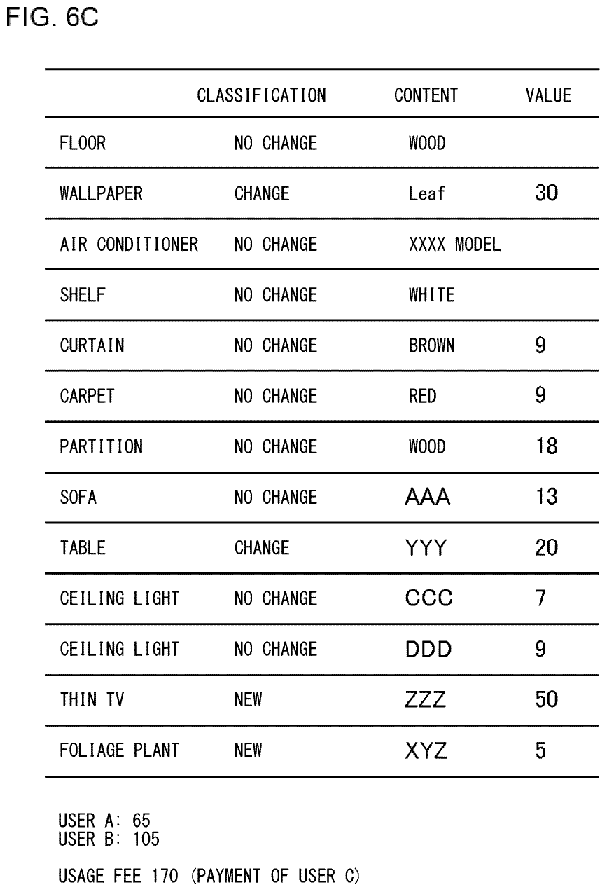

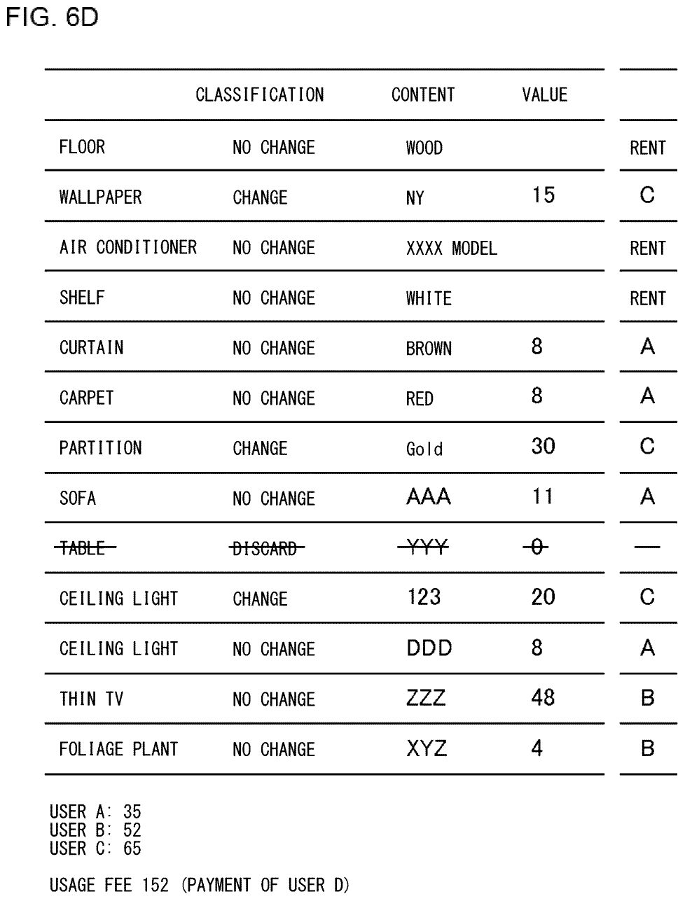

FIGS. 6A to 6D illustrate a data structure of space information. FIG. 6A illustrates space information acquired at timing before the time T1 in FIG. 1A. This is information before the user A moves into the residence 100 and is information of an article in the state of FIG. 2A. In FIG. 6A, since there is no article introduced by the user, the floor 10 and the like originally provided in the residence 100 are illustrated. The space information of FIG. 6A is stored in the storage device 330 as past space information.

FIG. 6B illustrates space information acquired at timing before the time T2 in FIG. 1A. This is information when the user A moves into the residence 100, and is information of an article in the state of FIG. 2B. An article included in FIG. 6B and not included in FIG. 6A corresponds to the first article. For example, the curtain 20 or the like is the first article. Although a numerical value is shown in a column of the value in FIG. 6B, the column of the value is blank at a stage where the processor 324 acquires the space information. The asset indicated in the first dwelling space information of the space information may include at least one of the first article to be left in the residence 100 and an intangible asset (hereinafter, also referred to as a “first intangible asset”) for the dwelling space. The first intangible asset is, for example, that, in a case where the first article is a device connectable to the network, a network is set for the first article. FIGS. 6C and 6D will be described later, and the description returns to FIG. 5.

The processor 324 derives the value of the first article based on the information regarding the first article included in the space information (S102). For example, the processor 324 acquires the fixed price of the first article by searching the database of the storage device 330 for the information regarding the first article. In addition, the processor 324 may acquire the fixed price of the first article by executing Internet search using the first article as a search key via the communicator 322. The processor 324 stores the acquired fixed price of the first article in the storage device 330.

Generally, the value of an article decreases as time elapses from manufacture. The processor 324 holds in advance a correspondence relation between the lapse of time from the manufacture of the article and the ratio of decrease in value (hereinafter, referred to as a “time-value decrease correspondence relation”). The “time-value decrease correspondence relation” is indicated by, for example, a linear function in which the ratio of decrease in value is “0” when the lapse of time is “0” and the ratio of decrease in value is “1” when the elapse of time is “10 years”. When the ratio of decrease in value is “0”, this indicates that the value is the fixed price, and when the ratio of decrease in value is “1”, this indicates that the value is “0”. Such a “time-value decrease correspondence relation” can be said to be a natural decrease in value. The “time-value decrease correspondence relation” is not limited to the linear function.

The processor 324 derives the value of the first article by reflecting the decrease in value with the lapse of time in the fixed price of the first article based on the “time-value decrease correspondence relation”. In a case where there are a plurality of first articles, the processor 324 derives the value of each first article by executing the above-described processing for each first article. The value derived as described above is illustrated as in FIG. 6B. The value may be indicated by an amount of money or may be indicated by a numerical value that can be converted into the amount of money.

In a case where the first article is a device connectable to the network, the value may be modified according to the network setting for the first article. For example, in a case where the network is set for the first article alone, a coefficient k is set to “0”, and in a case where a predetermined number of first articles are connected to the network in units of one room and cooperation of a plurality of first articles is set, the coefficient k is set to “1.1”. Further, in a case where at least one or more first articles are connected to the network in a plurality of rooms and cooperation across rooms is set, the coefficient k is set to “1.2”. Furthermore, the processor 324 modifies the value by value×(1+coefficient k).

The processor 324 determines a usage fee to be paid to the user A by the user B moving into the residence 100 after the user A based on the derived value of the first article (S104). For example, the processor 324 sets the value of the first article as the usage fee as it is. As illustrated in FIG. 6B, the sum of the values of the respective first articles is the first usage fee “86” to the user A, and the usage fee for the payment of the user B is also “86”.

The processor 324 causes the communicator 322 to output information including the determined first usage fee (S106). The communicator 322 transmits the information including the first usage fee to the second device 340 and the third device 350 via the network 310. Upon receiving the information including the first usage fee, the second device 340 and the third device 350 display the first usage fee on a display (not illustrated). The communicator 322 may transmit the information including the first usage fee to a system different from the information processing system 500. Subsequently, as illustrated in FIG. 1B, after moving into the residence 100, the user B pays the first usage fee to the user A. The information processing apparatus 320 may execute processing of collecting the first usage fee from the user B and paying the first usage fee to the user A. Since known technology may be used for the payment processing, the description thereof will be omitted here. In a case where the first article is discarded after the user B moves into the residence 100, the information processing apparatus 320 may send a message to the user A.

### (3-2) Processing at Timing Before Time T3

As described above, the leaving scheduled person 200 is the user B, and the resident scheduled person 202 is the user C. As described above, the first device 300 in FIG. 4 transmits the space information to the information processing apparatus 320. In FIG. 5, the communicator 322 of the information processing apparatus 320 receives the space information from the first device 300, and the processor 324 acquires the space information from the communicator 322 (S100). Processing similar to the above-described processing is performed on the space information. The space information includes information (second dwelling space information) regarding an article (hereinafter, referred to as a “second article”) that is introduced into the residence 100 by the user B and left in the residence 100 when the user B leaves the residence 100. Further, the space information also includes information regarding the first article left in the residence 100 when the user B leaves the residence 100 among the first articles introduced into the residence 100 by the user A.

FIG. 6C illustrates space information acquired at timing before the time T3 in FIG. 1A. This is information when the user B moves into the residence 100, and is information of an article in the state of FIG. 2C. An article included in FIG. 6C and not included in FIG. 6B corresponds to the second article. For example, the thin television receiver 40 or the like is the second article. The first wallpaper 12a is changed to a second wallpaper 12b, the first table 28a is changed to the second table 28b, and the second wallpaper 12b and the second table 28b are also the second articles. On the other hand, for example, the curtain 20 or the like is left as the first article. Here, it is assumed that the user B does not execute an act of changing the value of the first article, for example, remodeling of the first article while living in the residence 100. Therefore, the first article left by the user A and the second article left by the user B are clearly distinguished. Although a numerical value is also shown in a column of the value in FIG. 6C, the column of the value is blank at a stage where the processor 324 acquires the space information. The asset indicated in the second dwelling space information of the space information may include at least one of the second article to be left in the residence 100 and an intangible asset (hereinafter, also referred to as a “second intangible asset”) for the dwelling space. FIG. 6D will be described later, and the description returns to FIG. 5.

The processor 324 derives the value of the first article based on the information regarding the first article included in the space information, and derives the value of the second article based on the information regarding the second article included in the space information (S102). For example, the processor 324 acquires the fixed price of the second article by executing processing similar to that when the fixed price of the first article is acquired. In addition, the processor 324 derives the value of the second article by reflecting the decrease in value with the lapse of time in the fixed price of the second article based on the “time-value decrease correspondence relation”. On the other hand, the processor 324 acquires the fixed price of the first article stored in the storage device 330. Furthermore, the processor 324 derives the value of the first article by reflecting the decrease in value with the lapse of time in the fixed price of the first article. Since the time elapses from the timing before the time T2, the value of the first article further decreases from the value at the timing before the time T2.

In a case where there are a plurality of first articles or second articles, the processor 324 derives the value of each of the first articles or each of the second articles by executing the above-described processing for each of the first articles or each of the second articles. The value derived as described above is illustrated as in FIG. 6C. As such, the value is derived based on the cost invested in “new” or “change”. In a case where the first article or the second article is a device connectable to the network, the processor 324 may modify the value according to the network setting for the first article or the second article.

The processor 324 determines a first usage fee to be paid to the user A by the user C who moves into the residence 100 after the user B and a second usage fee to be paid to the user B by the user C, based on the value of the first article and the value of the second article (S104). For example, the processor 324 sets the value of the first article as the first usage fee and sets the value of the second article as the second usage fee. As illustrated in FIG. 6B, the sum of the values of the respective first articles is the first usage fee “65” to the user A, and the sum of the values of the respective second articles is the first usage fee “105” to the user B. Therefore, the usage fee for the payment of the user C is “170”.

The processor 324 causes the communicator 322 to output information including the first usage fee and the second usage fee (S106). The communicator 322 transmits the information including the usage fee to the second device 340 and the third device 350 via the network 310. Upon receiving the information including the first usage fee and the second usage fee, the second device 340 and the third device 350 display the usage fee on a display (not illustrated). The communicator 322 may transmit the information including the first usage fee and the second usage fee to a system different from the information processing system 500. Subsequently, as illustrated in FIG. 1C, after moving into the residence 100, the user C pays the first usage fee to the user A and pays the second usage fee to the user B. The information processing apparatus 320 may execute processing of collecting the first usage fee and the second usage fee from the user C, paying the first usage fee to the user A, and paying the second usage fee to the user B.

### (3-3) Processing at Timing Before Time T4 in FIG. 1A

The leaving scheduled person 200 is the user C, and the resident scheduled person 202 is the user D. Since the processing in this case is similar to that described above, the description thereof is omitted here. FIG. 6D illustrates space information acquired at timing before the time T4 in FIG. 1A. This is information when the user C moves into the residence 100, and is information of an article in the state of FIG. 2D. An article included in FIG. 6D and not included in FIG. 6C corresponds to a third article. The third article is an article that is introduced into the residence 100 by the user C and left in the residence 100 when the user C leaves the residence 100. Therefore, it can be said that the space information includes information regarding the third article (third dwelling space information). For example, the second wallpaper 12b is changed to a third wallpaper 12c, the first partition 24a is changed to the second partition 24b, and the third wallpaper 12c and the second partition 24b are the third articles. On the other hand, for example, the curtain 20 or the like is left as the first article, and the thin television receiver 40 or the like is left as the second article. Here, the first article left by the user A, the second article left by the user B, and the third article left by the user C are clearly distinguished.

The processor 324 derives the values of the first to third articles based on these pieces of information, similarly to the above, and determines the first usage fee to be paid to the user A, the second usage fee to be paid to the user B, and the third usage fee to be paid to the user C by the user D moving into the residence 100 after the user C. The sum of the values of the respective first articles is the first usage fee “35” to the user A, the sum of the values of the respective second articles is the first usage fee “52” to the user B, and the sum of the values of the respective third articles is the third usage fee “65” to the user C. Therefore, the usage fee for the payment of the user D is “152”. As illustrated in FIG. 1D, after moving into the residence 100, the user D pays the first usage fee to the user A, pays the second usage fee to the user B, and pays the third usage fee to the user C.

### (4) Second Processing Example

A second processing example relates to derivation of a value of an article in the processor 324. The value of the article may be derived as in (i) to (iii).
(i) The processor 324 may acquire the market price of the article as a value by executing the Internet search for the information regarding the article via the communicator 322. At that time, the Internet search is performed on the auction site. In a case where the market price is acquired as the value, the processor 324 may not reflect the decrease in value with the lapse of time in the market price of the first article.
(ii) A plurality of evaluators may be determined in advance for the field of the object of the article, and the value may be derived according to the evaluations of the plurality of evaluators. For example, each evaluator uses the second device 340 in FIG. 4, and the information processing apparatus 320 causes each second device 340 to display an image of the article. At that time, each second device 340 displays an image of the article at the time of leaving and an image of the article before moving into. Each evaluator inputs a two-stage evaluation such as good or bad to the second device 340 based on the displayed images of the article. The processor 324 of the information processing apparatus 320 derives the value of the article at the time of leaving based on the ratio or the absolute number of good evaluations and the value of the article before moving into. For example, in a case where the ratio of good evaluations is 50% and the value (price) of the article before moving into is 100,000 yen, the processor 324 derives the value of the article at the time of leaving by 100,000 yen×50/100 (ratio). At that time, an adjustment coefficient may be multiplied. The adjustment coefficient is set by the management company with a maximum value of 10%, for example.
(iii) The resident scheduled person 202 may determine the value of the article. In addition, a part of the value of the article may be adjustable by the resident scheduled person 202.

### (5) Third Processing Example

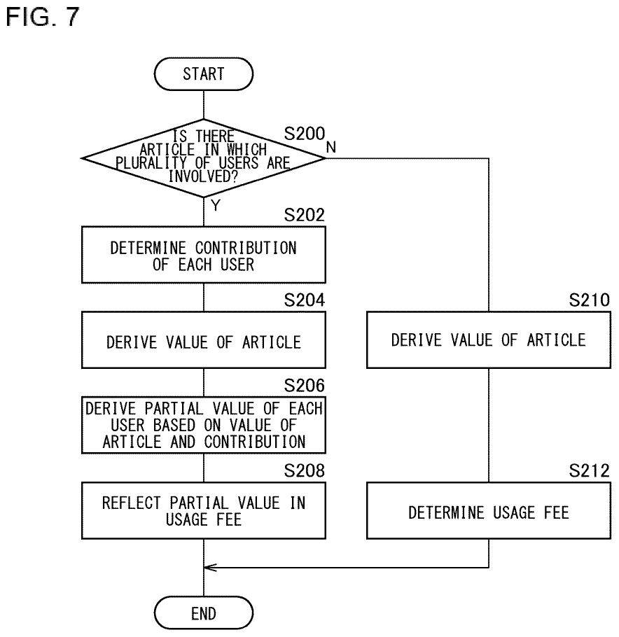

In the first processing example, the user B moving into the residence 100 does not execute an act of changing the value of the first article. On the other hand, in the third processing example, the user B moving into the residence 100 executes an action of changing the value of the first article. Further, the user C moving into the residence 100 may execute an action of changing the value of the first article or the second article. Hereinafter, the processing of the third processing example will be described with reference to FIG. 7.

FIG. 7 is a flowchart illustrating a procedure for determining a usage fee by the information processing apparatus 320. The processor 324 compares the space information at each timing to confirm whether there is an article in which a plurality of users are involved (S200). For example, if FIG. 2C and FIG. 2D, that is, FIG. 6C and FIG. 6D are compared, the first partition 24a is changed to the second partition 24b. The change is, for example, an action of replacing a sheet on a surface of the first partition 24a, and a partition 24 in which the sheet on the surface has been replaced is the second partition 24b. Such information may be included in space information configured as character information.

When there is the article in which the plurality of users are involved (Y in S200), the processor 324 determines a contribution of each user (S202). When the user B changes the value of the first article, the processor 324 determines a first contribution of the user A and a second contribution of the user B to the first article based on the action of the user B. The contribution is determined to be, for example, equal distribution. In this case, the first contribution is “0.5” and the second contribution is “0.5”. The contribution may be determined to be the distribution in which the inclination of the most recent user increases. In this case, the first contribution is “0.33”, and the second contribution is “0.67”.

The method for distributing the contribution may be changed depending on whether or not the value has increased as compared with that before the user B who is the leaving scheduled person 200 moves into. Whether or not the value has increased is specified by step 204 described later. When the value increases, the contribution is determined to be the distribution in which the inclination of the most recent user increases. In this case, the first contribution is “0.33”, and the second contribution is “0.67”. When the value decreases, the contribution is determined to be the distribution in which the inclination of the most recent user decreases. In this case, the first contribution is “0.67”, and the second contribution is “0.33”.

The processor 324 derives the value of the article based on the information regarding the article included in the space information (S204). This processing is similar to that described above, and in a case where the information regarding the first article and the information regarding the second article are included in the space information, the processor 324 derives the value of the first article and the value of the second article.

In a case where a plurality of users are involved in one article, the processor 324 derives a partial value (hereinafter, referred to as a “partial value”) of each user for the article based on the value of the article and the contribution. For example, in a case where the user A and the user B are involved in the first article, the processor 324 derives the partial value (hereinafter, referred to as a “first partial value”) of the user A by multiplying the changed value of the first article by the first contribution. In addition, the processor 324 derives the partial value (hereinafter, referred to as a “second partial value”) of the user A by multiplying the changed value of the first article by the second contribution. The processor 324 reflects the partial value in the usage fee (S208). For example, the processor 324 reflects the first partial value in the first usage fee and reflects the second partial value in the second usage fee. When there is no article in which the plurality of users are involved (N in S200), the processor 324 derives a value of the article (S210), and determines a usage fee (S212). Since these are the same as steps 102 and 104 in FIG. 5, the description thereof is omitted here.

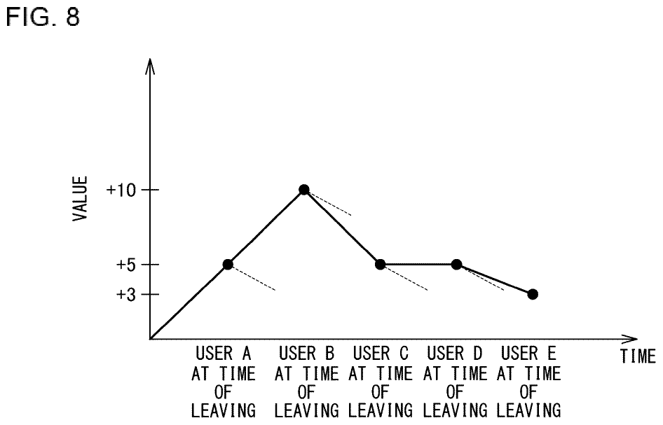

Hereinafter, a case where the value of the article changes due to the involvement of a plurality of users will be described with reference to FIG. 8. FIG. 8 illustrates a change in value in a case where a plurality of users are involved. A horizontal axis indicates time, and a vertical axis indicates the value of the article. The user A increases the value of the article by “5” at the timing of leaving. The user B increases the value of the article by “5” at the timing of leaving. The user C decreases the value of the article by “5” at the timing of leaving. The user D maintains the value of the article at the timing of leaving. The user E decreases the value of the article by “2” at the timing of leaving.

A dotted line shown at each timing indicates a natural decrease in value that occurs when the action of changing the value of the article is not executed. As described above, the natural decrease in value corresponds to the “time-value decrease correspondence relation”. Since the decrease in value by the user B is lower than the natural decrease, the user B substantially decreases the value of the article. On the other hand, since the decrease in value of the article by the user D and the user E is not lower than the natural decrease, the user D and the user E do not substantially decrease the value of the article. As such, the increase or decrease in value of the article at the timing when the user leaves may be determined in consideration of the natural decrease in value. Therefore, a partial value is generated in the user A, the user C, the user D, and the user E. No partial value is generated in the user B.

### (6) Fourth Processing Example

In a fourth processing example, another example of the value of the article is illustrated. In a case where a user who has introduced the article into the residence 100 or a user who has modified or added the article in the residence 100 has a significantly high evaluation, the value may also be derived for the action of the user after not changing the article introduced, modified, or added by the user. Therefore, a usage fee is also paid to the subsequent user. The action of the subsequent user in this case can be said to be maintenance of the article. Examples of the article are a wallpaper, a partition, a floor, and the like modified by a famous person. The object may be an article created by the famous person, or an article created by processing a commercially available product by the famous person.

The storage device 330 stores information regarding such an article. The information regarding the article includes information regarding the value of the article and information regarding a usage fee for the subsequent user. The usage fee for the subsequent user is determined, for example, as a certain ratio of the value of the article. The processor 324 of the information processing apparatus 320 specifies the value of the article and the usage fee for the subsequent user based on the information stored in the storage device 330.

The value may be derived for large furniture and interior designs. In this case, the information of the intangible asset includes information of a position of the large furniture. The information of the intangible asset includes, for example, an image captured by a 360-degree imaging device when the user leaves, and information of dimensions measured by a measurement tool. In a case where the leaving scheduled person 200 is the user B, the processor 324 derives the partial value for the user B by comparing the information of the first intangible asset when the user A leaves with the information of the second intangible asset when the user B leaves. For example, as the two pieces of information are close, the partial value for the user B increases. As the two pieces of information are different, the partial value for the user B may increase.

### (7) Fifth Processing Example

A fifth processing example relates to a case where, for example, when the user C leaves, when the user A does not consent to the first usage fee, or when the user B does not consent to the second usage fee, the user A or the user B raises an objection. The user A and the user B are users who have already left the residence 100.

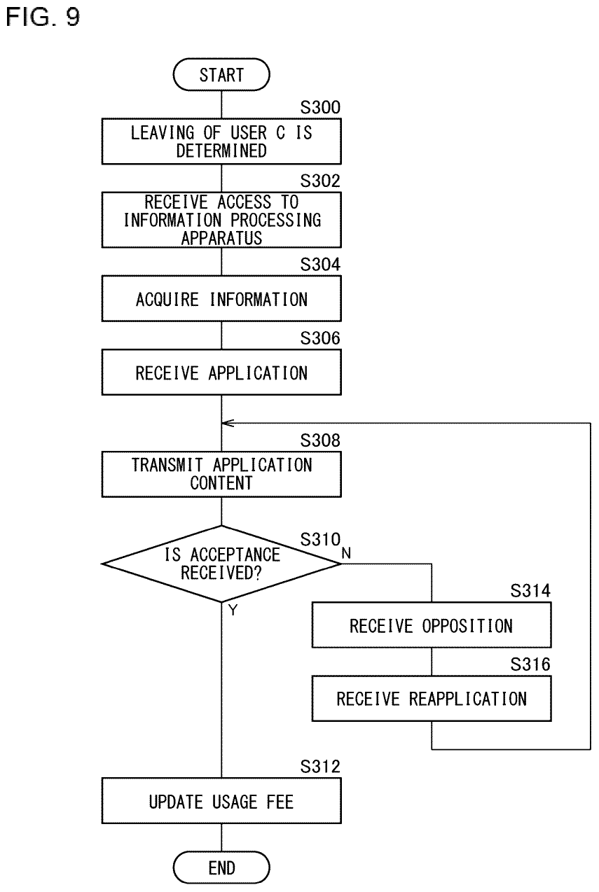

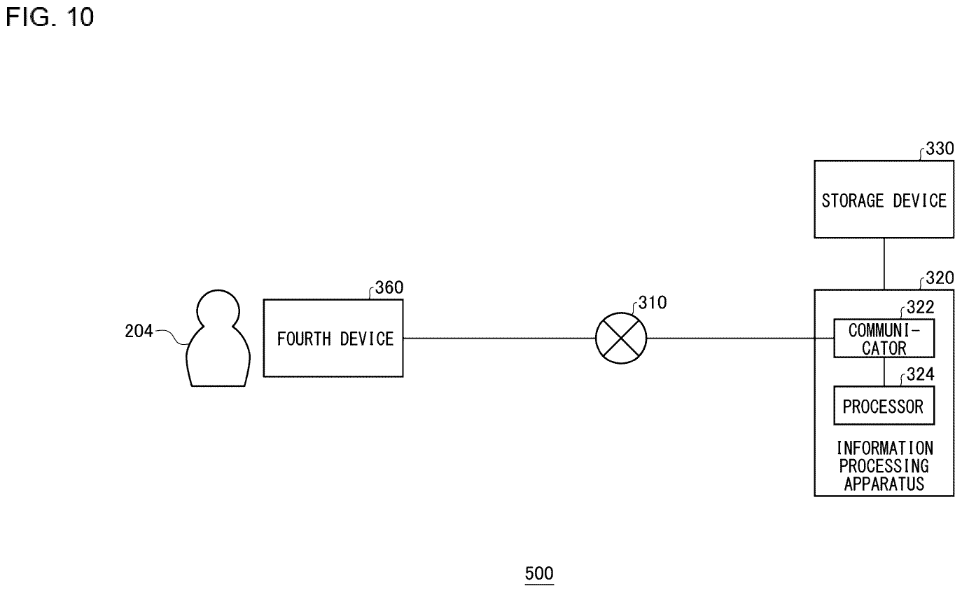

FIG. 9 is a flowchart illustrating an opposition procedure by the information processing system 500. The leaving of the user C is determined (S300). The communicator 322 receives access to the information processing apparatus 320 from the first device 300 of the residence 100 in which the user C moves into (S302). The processor 324 acquires the space information from the first device 300 via the communicator 322 (S304). In addition, the user C uses the first device 300 to apply for the change content of the article in the no change/change/new/discard classification together with the space information, and the processor 324 of the information processing apparatus 320 receives the application from the first device 300 via the communicator 322 (S306).

The processor 324 transmits information of the application content to a device (not illustrated) of the user A and a device (not illustrated) of the user B via the communicator 322 (S308). The user A and the user B confirms the application content of the user C and examine whether or not the application content is appropriate. When the acceptance of the application content is received from the device (not illustrated) of the user A and the device (not illustrated) of the user B via the communicator 322 (Y in S310), the processor 324 updates the usage fee, for example, the first usage fee, the second usage fee, and the third usage fee (S312). When the acceptance of the application content is not received from the device (not illustrated) of the user A or the device (not illustrated) of the user B via the communicator 322 (N in S310), the processor 324 receives an opposition from the device (not illustrated) of the user A or the device (not illustrated) of the user B via the communicator 322 (S314). When the opposition is transmitted to the first device 300 via the communicator 322, the processor 324 receives a reapplication from the first device 300 via the communicator 322 (S316). In the reapplication, the user C may modify the application content according to the content of the opposition. Subsequently, the process returns to step 308.

The reapplication may not be modified by the user C. For example, the modification may be preferentially performed by a user who has improved the value most or a user who has improved the value by a predetermined value or more among a plurality of users who have moved into the residence 100. Further, in a case where there is no user who has improved the value most or no user who has improved the value by the predetermined value or more, the modification may be performed by the user B who has moved into the residence 100 before the user C. The modification may be performed by a third party other than the user who has moved into the residence 100, for example, an employee of a management company.

### (8) Sixth Processing Example

A sixth processing example relates to a service for searching for the residence 100 where the above-described article has been installed. FIG. 10 illustrates another configuration of the information processing system 500. In the information processing system 500, the network 310, the information processing apparatus 320, and the storage device 330 are the same as those in FIG. 4. The information processing system 500 further includes a fourth device 360.

The fourth device 360 is, for example, an information terminal such as a personal computer, a tablet terminal, or a smartphone, and is used by a residence searcher 204 who searches for the residence 100 to move in. The residence searcher 204 operates the fourth device 360 to search for the residence 100, and the fourth device 360 transmits a request signal for requesting a search for the residence 100 to the information processing apparatus 320 via the network 310.

The storage device 330 stores a database of information regarding the residence 100 in which the above-described first asset is installed. The database includes space information or information obtained by modifying the space information. When the communicator 322 of the information processing apparatus 320 receives the request signal, the processor 324 searches the database of the storage device 330 according to the request signal. The communicator 322 transmits a search result in the processor 324 to the fourth device 360 via the network 310.

The fourth device 360 displays the received search result on the display. The residence searcher 204 confirms the search result displayed on the display to browse the residence 100 to be moved in. When the residence searcher 204 determines to move into the residence 100 included in the search result, the residence searcher 204 becomes the resident scheduled person 202 in FIG. 4.

Here, the request signal includes information regarding a network configuration provided in the residence in which the residence searcher 204 lives. The processor 324 searches for the residence 100 having a network compatible with the network of the residence in which the residence searcher 204 lives. As a network matching rate is higher, the more it is possible to collectively reflect (move) “account”, “standard function”, and the like.

The request signal may include information regarding the domestic electric machines and appliances installed in the residence in which the residence searcher 204 lives. The processor 324 searches for the residence 100 suitable for the domestic electric machines and appliances installed in the residence in which the residence searcher 204 lives. The same domestic electric machines and appliances may already be installed in the searched residence 100, or the same domestic electric machines and appliances may not be arranged. In the former case, the residence searcher 204 does not need to take the domestic electric machines and appliances to the residence 100, and in the latter case, the domestic electric machines and appliances can be used.

The request signal may include an image showing the interior or interior design of the residence in which the residence searcher 204 lives. The processor 324 searches for the residence 100 close to the interior or interior design of the residence in which the residence searcher 204 lives. It is possible to search for the residence 100 matched with the hobby of the residence searcher 204.

The residence searcher 204 may be able to directly contact a user who has moved into the residence 100. The residence searcher 204 can notify the user of the confirmation of preference, “succession of a request for modification”, and the like without going through the owner of the residence 100. In addition, the past user can transfer the right to receive the usage fee to a third party or another user.

According to the present embodiment, since the user A receives the first usage fee with respect to the value of the first article introduced into the residence 100, it is possible to improve the motivation of the user A for increasing the value of the residence 100. In addition, since the motivation of the user A is improved, the value of the residence 100 can be efficiently improved. In addition, since the first article introduced into the residence 100 is left, the first article does not need to be discarded. In addition, since the first article does not need to be discarded, the first article can be effectively used. In addition, since the asset indicated in the first dwelling space information includes at least one of the first article left in the residence 100 and the first intangible asset for the dwelling space, the value of the first asset can be derived.

In addition, since the user A receives the first usage fee with respect to the value of the first article introduced into the residence 100 and the user B receives the second usage fee with respect to the value of the second article, it is possible to improve the motivation of the user for increasing the value of the residence 100. In addition, since the motivation of the user is improved, the value of the residence 100 can be efficiently improved. In addition, since the second article introduced into the residence 100 is left, the second article does not need to be discarded. In addition, since the second article does not need to be discarded, the second article can be effectively used. In addition, since the asset indicated in the second dwelling space information includes at least one of the second article left in the residence 100 and the second intangible asset for the dwelling space, the value of the second asset can be derived.

In a case where the user B does not change the value of the first article, the first usage fee is determined based on the value of the first article, and the second usage fee is determined based on the value of the second article. Therefore, the first usage fee and the second usage fee can be appropriately set. In addition, in a case where the second user changes the value of the first article, the first contribution of the first user and the second contribution of the second user to the first article are determined, the first partial value based on the first contribution is reflected in the first usage fee, and the second partial value based on the second contribution is reflected in the second usage fee, so that the first usage fee and the second usage fee can be appropriately set.

Since the usage fee income scheme is configured for the user who has moved in the residence 100 in the past, the value of the residence 100 can be easily improved. In addition, since the value of the residence 100 is improved, a vacancy rate of the residence 100 can be reduced even if the geographical conditions of the residence 100 are inconvenient. In addition, since the vacancy rate of the residence 100 is reduced, real estate investment can be accelerated. In addition, in the case of the residence 100 operated by a famous person such as an artist/designer, since the fan of the famous person increases the value, it is possible to easily determine moving into the residence 100 even if the geographical conditions of the residence 100 are poor. In addition, since the resident calls the next resident through the service, an intermediary can be made unnecessary. In addition, the residence 100 has a wide risk range of return from the viewpoint of real estate investors, and can be treated favorably. In addition, even a third party other than the resident can be easily involved in the residence 100 by transferring the right to receive the usage fee and developing an auction or the like on the service.

An overview of one aspect of the present disclosure is as follows. A method for outputting a usage fee according to an aspect of the present disclosure is a method for outputting a facility usage fee by using dwelling space information that changes with entrance and exit of a facility. The method includes: acquiring the dwelling space information regarding an asset that a first user living in the facility introduces into the facility and leaves in the facility when the first user leaves the facility; deriving a value of the asset based on the dwelling space information; determining a usage fee to be paid to the first user by a second user moving into the facility after the first user, based on the value of the asset; and outputting the usage fee.

The asset indicated in the dwelling space information includes at least one of an article left in the facility and an intangible asset for a dwelling space.

The method further includes: in a case where the asset left in the facility by the first user is referred to as a first asset, acquiring first dwelling space information regarding the first asset left in the facility when the second user leaves the facility; acquiring second dwelling space information regarding a second asset that the second user introduces into the facility and leaves in the facility when the second user leaves the facility; deriving a value of the first asset based on the first dwelling space information; deriving a value of the second asset based on the second dwelling space information; determining a first usage fee to be paid to the first user and a second usage fee to be paid to the second user by a third user moving into the facility after the second user, based on the value of the first asset and the value of the second asset; and outputting the first usage fee and the second usage fee.

The first asset indicated in the first dwelling space information may include at least one of a first article to be left in the facility and a first intangible asset for the dwelling space. The second asset indicated in the second dwelling space information includes at least one of a second article left in the facility and a second intangible asset for the dwelling space.

The second user does not execute an action of changing the value of the first asset while living in the facility. The determining of the first usage fee to be paid to the first user and the second usage fee to be paid to the second user includes determines the first usage fee based on the value of the first asset, and determines the second usage fee based on the value of the second asset.

The second user executes an action of changing the value of the first asset while living in the facility. The deriving of the value of the first asset determines a first contribution of the first user and a second contribution of the second user to the first asset based on the action of the second user, and derives a first partial value based on the changed value of the first asset and the first contribution and derives a second partial value based on the changed value of the first asset and the second contribution. The determining of the first usage fee to be paid to the first user and the second usage fee to be paid to the second user reflects the first partial value in the first usage fee, and reflects the second partial value in the second usage fee.

Another aspect of the present disclosure is an information processing apparatus. This apparatus is an information processing apparatus for outputting a facility usage fee by using dwelling space information that changes with entrance and exit of a facility. The information processing apparatus includes: a communicator that acquires the dwelling space information regarding an asset that a first user living in the facility introduces into the facility and leaves in the facility when the first user leaves the facility; and a processor that derives a value of the asset based on the dwelling space information acquired in the communicator, and determines a usage fee to be paid to the first user by a second user moving into the facility after the first user, based on the value of the asset. The communicator outputs the usage fee.

Still another aspect of the present disclosure is an information processing system. The information processing system includes: a first apparatus; a second apparatus; and an information processing apparatus that outputs a facility usage fee by using dwelling space information that changes with entrance and exit of a facility. The information processing apparatus includes: a communicator that acquires, from the first apparatus, the dwelling space information regarding an asset that a first user living in the facility introduces into the facility and leaves in the facility when the first user leaves the facility; and a processor that derives a value of the asset based on the dwelling space information acquired in the communicator, and determines a usage fee to be paid to the first user by a second user moving into the facility after the first user, based on the value of the asset. The communicator outputs the usage fee to the second apparatus.

The present disclosure has been described based on the embodiments. The embodiments are merely examples, and it is understood by those skilled in the art that various modifications can be made in the combination of the respective components or the respective processes, and that the modifications are also within the scope of the present disclosure.

What is claimed is:

1. A method for outputting a facility usage fee by using dwelling space information that changes with entrance and exit of a facility, the method comprising:
acquiring the dwelling space information regarding an asset that a first user living in the facility introduces into the facility and leaves in the facility when the first user leaves the facility;
deriving a value of the asset based on the dwelling space information;
determining a usage fee to be paid to the first user by a second user moving into the facility after the first user, based on the value of the asset; and
outputting the usage fee.

2. The method for outputting a usage fee according to claim 1, wherein
the asset indicated in the dwelling space information includes at least one of an article left in the facility and an intangible asset for a dwelling space.

3. The method for outputting a usage fee according to claim 1, further comprising:
in a case where the asset left in the facility by the first user is referred to as a first asset, acquiring first dwelling space information regarding the first asset left in the facility when the second user leaves the facility;
acquiring second dwelling space information regarding a second asset that the second user introduces into the facility and leaves in the facility when the second user leaves the facility;
deriving a value of the first asset based on the first dwelling space information;
deriving a value of the second asset based on the second dwelling space information;
determining a first usage fee to be paid to the first user and a second usage fee to be paid to the second user by a third user moving into the facility after the second user, based on the value of the first asset and the value of the second asset; and
outputting the first usage fee and the second usage fee.

4. The method for outputting a usage fee according to claim 3, wherein
the first asset indicated in the first dwelling space information includes at least one of a first article left in the facility and a first intangible asset for the dwelling space, and
the second asset indicated in the second dwelling space information includes at least one of a second article left in the facility and a second intangible asset for the dwelling space.

5. The method for outputting a usage fee according to claim 3, wherein
the second user does not execute an action of changing the value of the first asset while living in the facility, and
the determining of the first usage fee to be paid to the first user and the second usage fee to be paid to the second user determines the first usage fee based on the value of the first asset, and determines the second usage fee based on the value of the second asset.

6. The method for outputting a usage fee according to claim 3, wherein
the second user executes an action of changing the value of the first asset while living in the facility,
the deriving of the value of the first asset
determines a first contribution of the first user and a second contribution of the second user to the first asset based on the action of the second user, and
derives a first partial value based on the changed value of the first asset and the first contribution and derives a second partial value based on the changed value of the first asset and the second contribution, and
the determining of the first usage fee to be paid to the first user and the second usage fee to be paid to the second user
reflects the first partial value in the first usage fee, and reflects the second partial value in the second usage fee.

7. An information processing apparatus for outputting a facility usage fee by using dwelling space information that changes with entrance and exit of a facility, the information processing apparatus comprising:
a communicator structured to acquire the dwelling space information regarding an asset that a first user living in the facility introduces into the facility and leaves in the facility when the first user leaves the facility; and
a processor structured to derive a value of the asset based on the dwelling space information acquired in the communicator, and determine a usage fee to be paid to the first user by a second user moving into the facility after the first user, based on the value of the asset, wherein
the communicator outputs the usage fee.

8. A storage medium storing a program executed in an information processing apparatus for outputting a facility usage fee by using dwelling space information that changes with entrance and exit of a facility, the program causing a computer to execute:
acquiring the dwelling space information regarding an asset that a first user living in the facility introduces into the facility and leaves in the facility when the first user leaves the facility;
deriving a value of the asset based on the dwelling space information;
determining a usage fee to be paid to the first user by a second user moving into the facility after the first user, based on the value of the asset; and
outputting the usage fee.

9. An information processing system comprising:
a first apparatus;
a second apparatus; and
an information processing apparatus structured to output a facility usage fee by using dwelling space information that changes with entrance and exit of a facility, wherein
the information processing apparatus includes
a communicator structured to acquire, from the first apparatus, the dwelling space information regarding an asset that a first user living in the facility introduces into the facility and leaves in the facility when the first user leaves the facility, and
a processor structured to derive a value of the asset based on the dwelling space information acquired in the communicator, and determine a usage fee to be paid to the first user by a second user moving into the facility after the first user, based on the value of the asset, and
the communicator outputs the usage fee to the second apparatus.
